(19) United States
(12) Patent Application Publication
(10) Pub. No.: US 2011/0234458 A1
(43) Pub. Date: Sep. 29, 2011

(54) MOBILE TERMINAL APPARATUS

(75) Inventors: Hiroshi Kubo, Kawasaki (JP); Hiroyuki Takita, Kawasaki (JP); Haruyoshi Yada, Kawasaki (JP); Kenta Sugimori, Kawasaki (JP); Yoshifumi Kajiwara, Kawasaki (JP); Kazunobu Yoneyama, Kawasaki (JP)

(73) Assignee: FUJITSU LIMITED, Kawasaki-shi (JP)

(21) Appl. No.: 13/051,389

(22) Filed: Mar. 18, 2011

(30) Foreign Application Priority Data
Mar. 26, 2010 (JP) 2010-72098

(51) Int. Cl. H01Q 1/24

(52) U.S. Cl. 343/702

(57) ABSTRACT

A mobile terminal apparatus includes an antenna; a front outer case having a recess formed therein that houses the antenna, the recess having a first through hole and a second through hole, the first through hole penetrating through a side wall of the front outer case in one end of the recess and the second through hole penetrating through a bottom surface of the recess; and a supporting member that has a supporting hole formed therein, the supporting hole supporting the antenna that is inserted through the first through hole of the front outer case, at least a portion of the supporting member being inserted through the second through hole in a watertight manner and connecting the antenna supported by the supporting hole to a substrate.

### CROSS-REFERENCE TO RELATED APPLICATIONS

This application is based upon and claims the benefit of priority from the prior Japanese Patent Application No. 2010-72098 filed on Mar. 26, 2010, the entire contents of which are incorporated herein by reference.

### FIELD

The present invention relates to a mobile terminal apparatus.

### BACKGROUND

Recently, mobile terminal apparatuses such as mobile phone apparatuses feature a variety of functions such as a waterproof property and an audiovisual capability for watching and listening to one-segment broadcasting and terrestrial digital broadcasting. Japanese Laid-open Patent Publication No. 2009-268154 discloses a mobile terminal apparatus that includes an antenna externally mounted to a side of a casing or the like and features a waterproof property in a portion where the antenna is mounted.

Referring to FIGS. 11 and 12, a mobile phone apparatus including an externally mounted antenna will be described. FIGS. 11 and 12 illustrate a folding-type mobile phone apparatus 300 as an example, in which a fixed casing 320 including an operation portion is foldably connected to a movable casing 310 including a display portion. FIG. 11 is a perspective view illustrating an example of the appearance of the related art mobile phone apparatus 300 including an externally mounted antenna 330. The mobile phone apparatus 300 includes the movable casing 310 and the fixed casing 320. FIG. 11 illustrates a state in which the movable casing 310 has been folded onto the fixed casing 320. The fixed casing 320 has a groove formed at a side wall thereof. The antenna 330 is retracted into this groove.

FIG. 12 is an exploded perspective view of the externally mounted antenna 330. The fixed casing 320 has a recess 321, which is a groove formed in the side wall, into which the antenna 330 is retracted. The fixed casing 320 also has a tapped hole 322 used to secure the antenna 330. The recess 321 has a securing hole 321a formed therein used to secure the antenna 330. The antenna 330 includes a protrusion 331 formed thereon that is engaged with the securing hole 321a and a movable member 333 mounted thereto, in which a through hole 332 is formed.

The protrusion 331 is engaged with the securing hole 321a and a fastening member 334 is inserted into the tapped hole 322 through the through hole 332. Thus, the antenna 330 is secured to the fixed casing 320. To make the mobile phone apparatus 300 have a waterproof property, for example, an O-ring, which is a waterproof member, is attached to the protrusion 331, and the protrusion 331 is engaged with the securing hole 321a in a watertight manner. The user of the above-described mobile phone apparatus 300 may retract the antenna 330 into the recess 321 and pull out the antenna 330 from the recess 321 with the protrusion 331 of the antenna 330 engaged with the securing hole 321a.

However, there is a problem with the mobile phone apparatus 300 disclosed in FIGS. 11 and 12 in that the antenna 330 may be damaged. More specifically, the externally mounted antenna is vulnerable to external impact because it is constantly positioned at the outside of the mobile phone apparatus 300. For example, even when the antenna 330 is retracted into the recess 321, it is still in an exposed state. Therefore, the antenna 330 is vulnerable to external impact and may still be damaged.

### SUMMARY

According to an aspect of the invention, a mobile terminal apparatus includes an antenna; a front outer case having a recess formed therein that houses the antenna, the recess having a first through hole and a second through hole, the first through hole penetrating through a side wall of the front outer case in one end of the recess and the second through hole penetrating through a bottom surface of the recess; and a supporting member that has a supporting hole formed therein, the supporting hole supporting the antenna that is inserted through the first through hole of the front outer case, the supporting member being inserted through the second through hole in a watertight manner and connecting the antenna supported by the supporting hole to a substrate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a perspective view illustrating an example of the appearance of the front surface side of the mobile phone apparatus according to the present embodiment;

FIG. 2 is a perspective view illustrating an example of the appearance of the rear surface side of the mobile phone apparatus according to the present embodiment;

FIG. 3 illustrates part of the fixed casing of the mobile phone apparatus illustrated in FIG. 1, from which the movable casing has been removed;

FIG. 4 is an enlarged perspective view illustrating components attached to the antenna of the present embodiment;

FIG. 5 illustrates the fixed casing without the cover mounted over the recess;

FIG. 6 illustrates the fixed casing seen from the direction of the arrow B in FIG. 5 without the rear outer case attached;

FIG. 7 is a perspective view illustrating the appearance of the fixed casing with the cover mounted over the recess;

FIG. 8 is an exploded perspective view illustrating the swing mechanism of the mobile phone apparatus according to the present embodiment;

FIG. 9 is a schematic diagram illustrating a section taken along I-I line of FIG. 2;

FIG. 10 is a perspective view illustrating an example of the appearance of a folding-type mobile phone apparatus;

FIG. 11 is a perspective view illustrating an example of the appearance of the related art mobile phone apparatus including an externally mounted antenna; and

FIG. 12 is an exploded perspective view of the externally mounted antenna of FIG. 11.

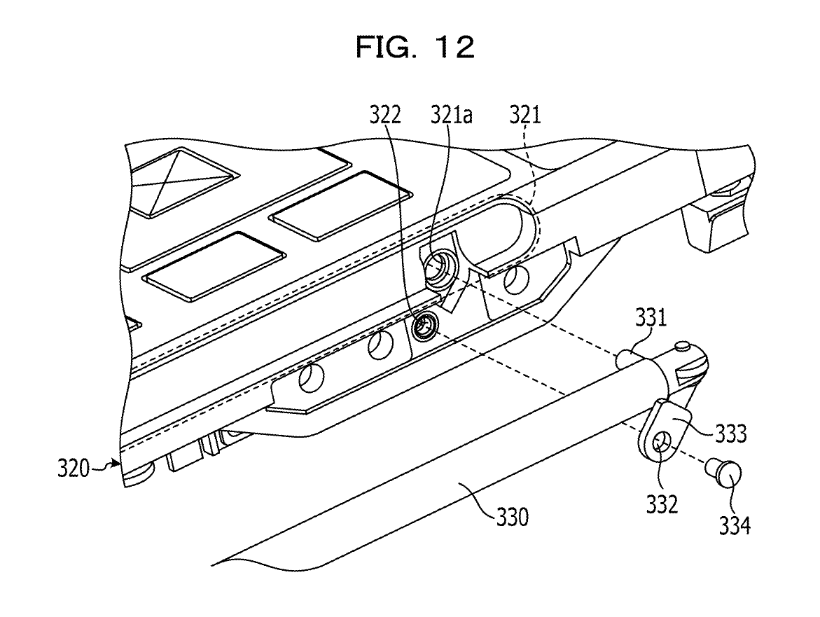

### DESCRIPTION OF EMBODIMENTS

An embodiment of a mobile terminal apparatus disclosed herein will be described in detail below with reference to the drawings. The present embodiment is not intended to limit the mobile terminal apparatus disclosed herein to a mobile phone apparatus. For example, the technology of the mobile terminal apparatus disclosed herein is also applicable to other mobile terminal apparatuses such as personal digital assistants (PDAs). The present embodiment illustrates an example where the technology of the mobile terminal apparatus disclosed herein is applied to a slide-type mobile phone apparatus in which a fixed casing and a movable casing are connected so as to be slidable relative to each other.

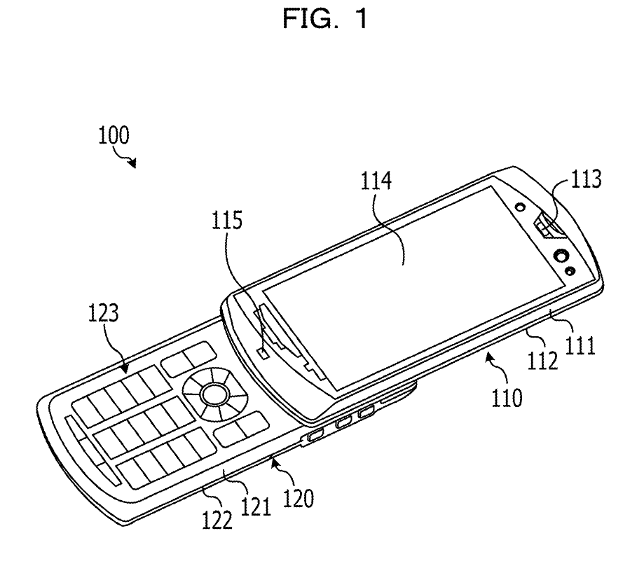

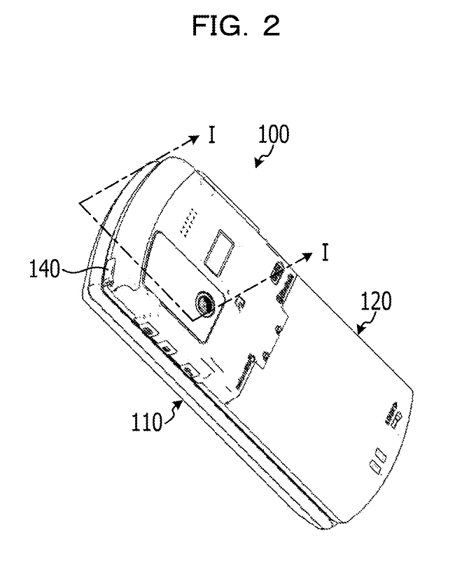

Referring to FIGS. 1 and 2, the appearances of a mobile phone apparatus 100 according to the present embodiment will be described. FIG. 1 is a perspective view illustrating an example of the appearance of the front surface side of the mobile phone apparatus 100 according to the present embodiment. The mobile phone apparatus 100 according to the present embodiment includes a movable casing 110 and a fixed casing 120.

In the present embodiment, surfaces of the movable casing 110 and the fixed casing 120 may be referred to as follows. That is, a surface of the movable casing 110 that includes a liquid crystal display 114 may be referred to as a “front surface,” a surface of the movable casing 110 that is opposite to the surface of the movable casing 110 that includes the liquid crystal display 114 may be referred to as a “rear surface,” a surface of the fixed casing 120 that includes operation keys may be referred to as a “front surface,” and a surface of the fixed casing 120 that is opposite to the surface of the fixed casing 120 that includes operation keys may be referred to as a “rear surface.”

The movable casing 110 and the fixed casing 120 are movably connected to each other with a connecting portion (not illustrated). The connecting portion includes a sliding mechanism that slidably connects the movable casing 110 to the fixed casing 120. FIG. 1 illustrates an open state where the movable casing 110 has been slid out and overlaps the fixed casing 120 with a minimum overlapping area. In general, when not in use, the slide-type mobile phone apparatus 100 is in a closed state where the movable casing 110 overlaps the fixed casing 120 with a maximum overlapping area. To operate the keys provided in the fixed casing 120, the movable casing 110 is slid relative to the fixed casing 120 in a longitudinal direction in order to set the mobile phone apparatus 100 in the open state.

The movable casing 110 includes a front outer case 111 and a rear outer case 112. The front outer case 111 is included in an outer surface of the mobile phone apparatus 100 in the closed state. The rear outer case 112 is positioned on the inner side of the mobile phone apparatus 100 in the closed state.

The front outer case 111 includes components such as a receiver portion 113 that receives speech and sounds during a call, the liquid crystal display 114 that displays a variety of information, and an opening 115 that penetrates through the front outer case 111. The opening 115 is a through hole that communicates with a microphone (not illustrated) provided on the front surface side inside the movable casing 110. Speech uttered by a user reaches the inside of the movable casing 110 through the opening 115 and is picked up by the microphone.

The fixed casing 120 includes a front outer case 121 and a rear outer case 122. The front outer case 121 is positioned on the inner side of the mobile phone apparatus 100 in the closed state. The rear outer case 122 is included in the outer surface of the mobile phone apparatus 100 in the closed state. The front outer case 121 includes a key pad 123, in which operation keys such as multi-function keys, an Enter key, dial keys and a ten key are provided.

FIG. 2 is a perspective view illustrating an example of the appearance of the rear surface side of the mobile phone apparatus 100 according to the present embodiment. FIG. 2 illustrates a closed state where the movable casing 110 overlaps the fixed casing 120 with the maximum overlapping area. The fixed casing 120 of the mobile phone apparatus 100 according to the present embodiment includes an antenna 140 therein.

The antenna 140 is, for example, for receiving terrestrial digital broadcasting and one-segment broadcasting. The antenna 140 has a structure, for example, in which tubular members of different diameters are telescopically connected to each other in a longitudinal direction. FIG. 2 illustrates an example of a retracted state in which the tubular members have been retracted one inside the other with a maximum overlapping area. The antenna 140 in the retracted state is retracted into the fixed casing 120.

In the mobile phone apparatus 100 according to the present embodiment, the antenna 140 is retracted into the fixed casing 120. This may prevent the antenna 140 from being subjected to external impact. As a result, damage to the antenna 140 of the mobile phone apparatus 100 according to the present embodiment may be prevented. The antenna 140 of the mobile phone apparatus 100 according to the present embodiment is equipped with a waterproof structure.

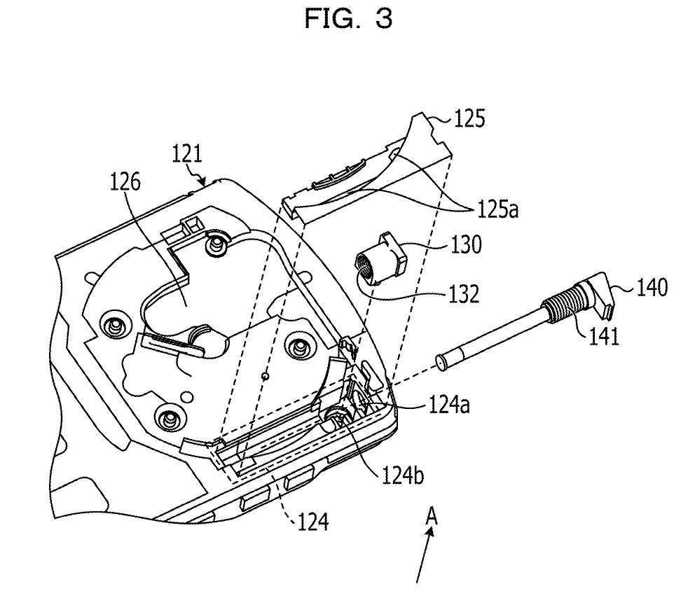

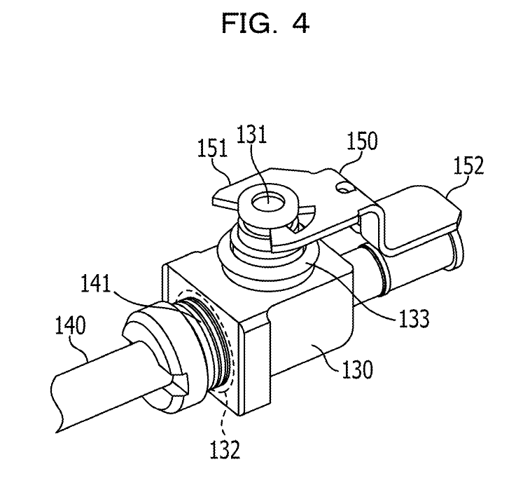

Referring to FIGS. 3 and 4, the antenna 140 provided in the fixed casing 120 will be described. FIG. 3 is a perspective view illustrating the appearance of an inner structure of the fixed casing 120 according to the present embodiment. FIG. 3 illustrates part of the fixed casing 120 of the mobile phone apparatus 100 illustrated in FIG. 1, from which the movable casing 110 has been removed. FIG. 4 is an enlarged perspective view illustrating components attached to the antenna 140 of the present embodiment. The enlarged perspective view in FIG. 4 illustrates the components as seen in the direction indicated by arrow A in FIG. 3, that is, as seen from the rear surface side of the fixed casing 120.

As illustrated in FIG. 3, the front outer case 121 of the fixed casing 120 has a recess 124 formed therein. A supporting member 130 is inserted into the recess 124. A cover 125 is mounted over the recess 124 at an upper side of the recess 124. The antenna 140 is supported by the supporting member 130.

The recess 124 is a groove formed in the front outer case 121, extending from the front surface toward the rear surface. The recess 124 is formed so as to have a space sufficient to house the antenna 140 at least in the retracted state. A through hole 124a that penetrates through a side wall of the front outer case 121 is formed in one longitudinal end of the recess 124. Another through hole 124b that penetrates through the front outer case 121 from a bottom surface is formed in the recess 124. An area, which is positioned closer to the side of the rear surface of the fixed casing 120 than the front outer case 121 is, a waterproof area where, for example, components such as a substrate are disposed. In other words, the through hole 124b is a hole that connects a non-waterproof area to the waterproof area in the fixed casing 120.

The supporting member 130, which is a waterproof member, supports the antenna 140. More specifically, as illustrated in FIG. 4, the supporting member 130 includes a protrusion 131 to which an O-ring 133, which is also a waterproof member, is attached. The protrusion 131 is inserted through the through hole 124b of the recess 124 in a watertight manner. The supporting member 130 has a supporting hole 132 formed therein that supports the antenna 140. The supporting hole 132 is formed to be, for example, a tapped hole.

The antenna 140 has a structure, for example, in which tubular members of different diameters are telescopically connected in a longitudinal direction. In a portion of the antenna 140, an engaging portion 141 that includes a screw thread is formed. The antenna 140 is inserted through the through hole 124a in a state in which the supporting member 130 has been inserted into the recess 124. The antenna 140 is supported by the supporting member 130 in such a manner that the engaging portion 141 thereof is screwed into the supporting hole 132 of the supporting member 130. In other words, the antenna 140 is secured to the recess 124 with the supporting member 130. When, for example, the free end of the antenna 140, which is exposed at the side wall of the front outer case 121, is pulled away from the front outer case 121, the antenna 140 is extended out of the fixed casing 120 while the engaging portion 141 is supported by the supporting hole 132 of the supporting member 130.

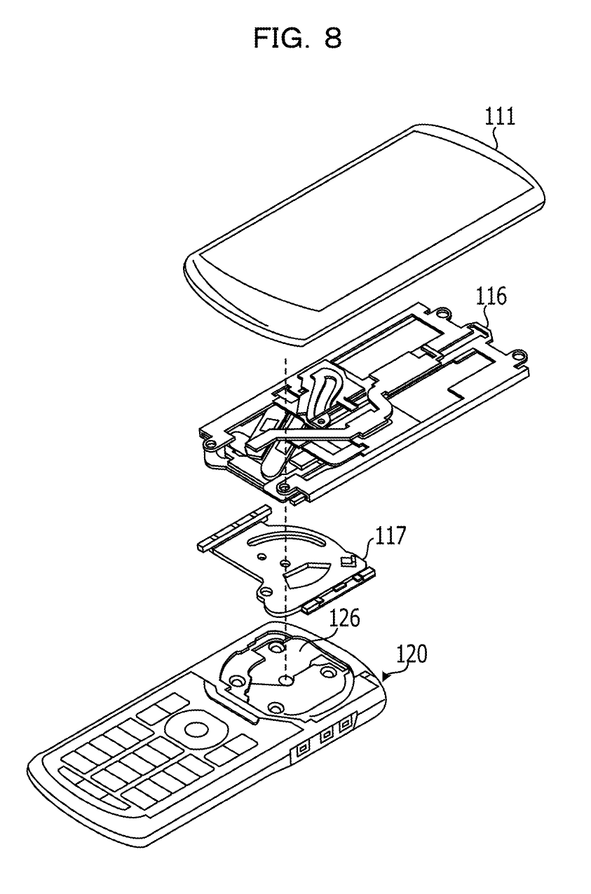

The cover 125 is mounted over the recess 124 on the front surface side. The cover 125 may prevent the movable casing 110 from contacting the antenna 140 when the movable casing 110 moves. Thus, damage to the antenna 140 may be prevented. As illustrated in FIG. 3, the front outer case 121 has a base plate 126 formed in the front surface thereof. The base plate 126 is provided because the mobile phone apparatus 100 according to the present embodiment is not only a slide-type mobile phone apparatus but also a swing-type mobile phone apparatus, in which the movable casing 110 rotates while remaining parallel to the fixed casing 120. The base plate 126 will be described below in detail with reference to FIG. 8.

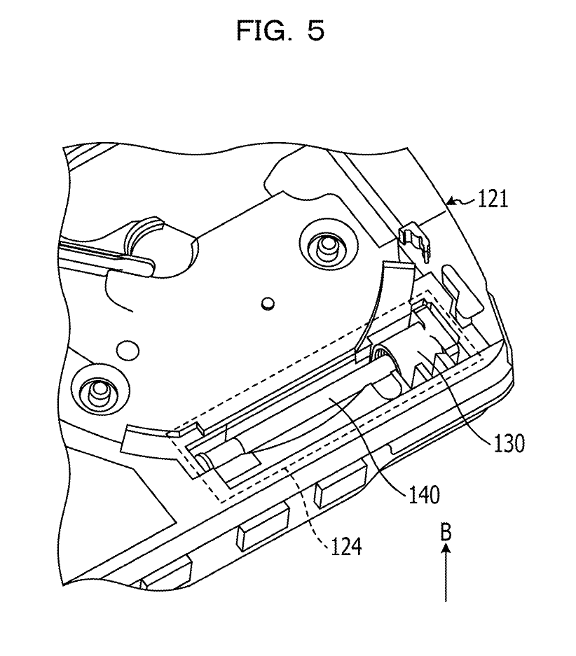

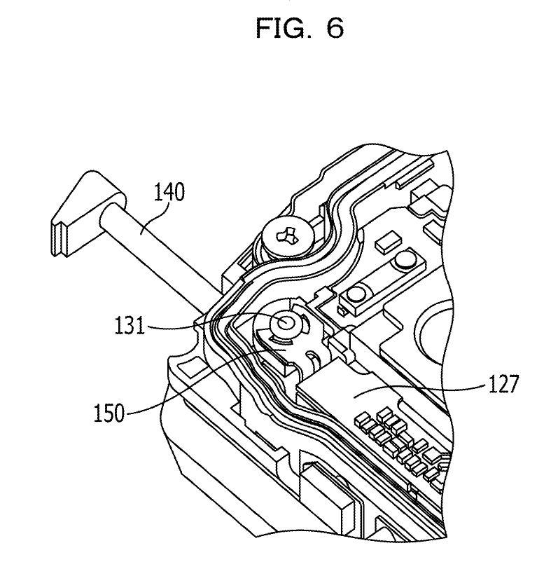

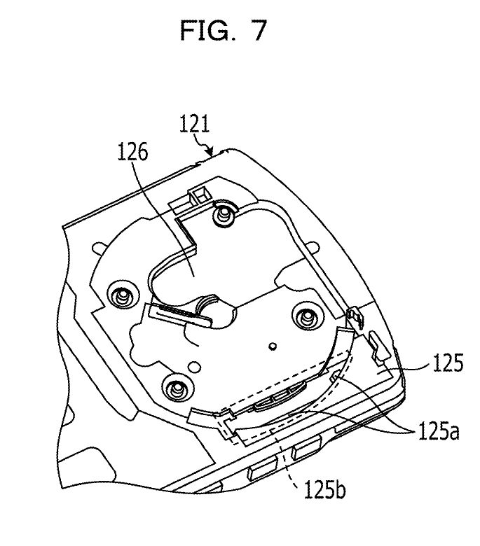

Referring to FIGS. 5 to 7, the way in which a variety of components including the antenna 140 are mounted in the fixed casing 120 will be described. FIGS. 5 to 7 are perspective views illustrating examples of the appearances of the fixed casing 120 in which the antenna 140 according to the present embodiment is mounted. FIG. 5 illustrates the fixed casing 120 without the cover 125 mounted over the recess 124. FIG. 6 illustrates the fixed casing 120 seen from the direction of the arrow B in FIG. 5 without the rear outer case 122 attached. That is, FIG. 6 illustrates a perspective view of the fixed casing 120 seen from the rear surface side without the rear outer case 122 attached. FIG. 7 is a perspective view illustrating the appearance of the fixed casing 120 with the cover 125 mounted over the recess 124.

As described in FIG. 5, the supporting member 130 is inserted into the recess 124 in the fixed casing 120. The antenna 140 is inserted through the through hole 124a, which penetrates through the front outer case 121 and reaches the recess 124, and the supporting hole 132 of the supporting member 130. The antenna 140 is supported by the supporting member 130 in such a manner that the engaging portion 141 thereof is screwed into the supporting hole 132 of the supporting member 130. The antenna 140 is retracted into the recess 124 in the retracted state.

As illustrated in FIG. 6, the protrusion 131 of the supporting member 130 is inserted through the through hole 124b of the recess 124 in a watertight manner and reaches the waterproof area. In an example illustrated in FIG. 6, components such as a substrate 127 are disposed in the waterproof area. A metal retainer 150 is attached to a portion of the protrusion 131 that reaches the waterproof area. As illustrated in FIG. 4, the metal retainer 150 includes a retaining portion 151 used to secure the protrusion 131 and a connecting portion 152 that is connected to the substrate 127. That is, the supporting member 130 also functions to connect the antenna 140 to the substrate 127 disposed in the waterproof area of the fixed casing 120. More specifically, by inserting the protrusion 131 of the supporting member 130 through the through hole 124b of the recess 124, the antenna 140 supported by the supporting hole 132 is connected to the substrate 127 using the metal retainer 150.

The protrusion 131 of the supporting member 130 blocks the through hole 124b that connects the recess 124, which is the non-waterproof area, to the waterproof area in a watertight manner. By doing this, the supporting member 130 may connect the antenna 140 to the substrate 127 while the waterproof property is maintained.

As illustrated in FIG. 7, the cover 125 includes discharge holes 125a formed therein that reach the recess 124 from the front surface side of the fixed casing 120. The discharge holes 125a facilitate discharging of water having entered the recess 124 to the outside of the recess 124. As illustrated in FIG. 7, the cover 125 includes a slide groove 125b formed therein, which functions in cooperation with a slide groove of the base plate 126.

A swing mechanism of the mobile phone apparatus 100 will be described with reference to FIG. 8. FIG. 8 is an exploded perspective view illustrating the swing mechanism of the mobile phone apparatus 100 according to the present embodiment. As illustrated in FIG. 8, a rail plate 116 and a swing plate 117 are mounted in the movable casing 110. The rail plate 116 slides together with the movable casing 110 in an integral manner along a groove in a convex portion formed in a peripheral portion of the front outer case 121 of the fixed casing 120. The swing plate 117 is engaged with the base plate 126 of the fixed casing 120. For example, a central portion of the swing plate 117 is engaged with a central portion of the base plate 126. The swing plate 117 rotates together with the movable casing 110 in an integrated manner around the portion of the swing plate 117 that is engaged with the base plate 126. At this time, the swing plate 117 slides along the slide groove of the base plate 126 in order to rotate together with the movable casing 110 in an integrated manner.

In the swing-type mobile phone apparatus 100, the swing plate 117 provided in the movable casing 110 slides along the slide groove of the base plate 126 provided in the fixed casing 120. By doing this, the movable casing 110 rotates while remaining parallel to the fixed casing 120. In the mobile phone apparatus 100 according to the present embodiment, the slide groove 125b is formed in the cover 125 mounted over the recess 124. By doing this, the swing plate 117 of the movable casing 110 may slide along the slide groove of the base plate 126.

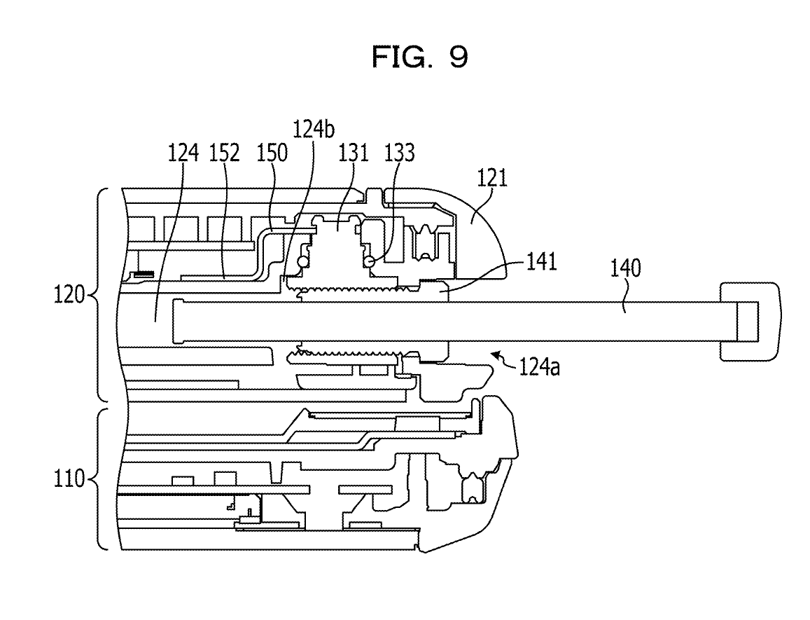

Referring to FIG. 9, a section of the mobile phone apparatus 100 near the antenna 140 will be described. FIG. 9 is a schematic diagram illustrating a section taken along I-I line of FIG. 2. As illustrated in FIG. 9, the front outer case 121 of the fixed casing 120 has the recess 124 formed therein. The through hole 124a that penetrates through the side wall of the front outer case 121 and another through hole 124b that communicates with the waterproof area where the components including the substrate 127 are disposed are formed in one longitudinal end of the recess 124.

The protrusion 131 of the supporting member 130 to which the O-ring 133, which is the waterproof member, is attached is inserted through the through hole 124b of such a recess 124 in a watertight manner. The metal retainer 150 is mounted in a portion of the protrusion 131 that is inserted through the through hole 124b and reaches the waterproof area. By doing this, the supporting member 130 is secured using the metal retainer 150. The antenna 140 is inserted through the through hole 124a of the front outer case 121. The antenna 140 is supported by the supporting member 130 in such a manner that the engaging portion 141 of the antenna 140 is screwed into the supporting hole 132 of the supporting member 130. By doing this, the supporting member 130 electrically connects the antenna 140 to the substrate 127 and so forth through the metal retainer 150.

The through hole 124b is preferably formed near the through hole 124a because the supporting member 130 is inserted at a position where the through hole 124b is formed. That is, by positioning the supporting member 130 that supports the antenna 140 near the through hole 124a, the antenna 140 is pulled away from the front outer case 121 in a stable manner without shaking.

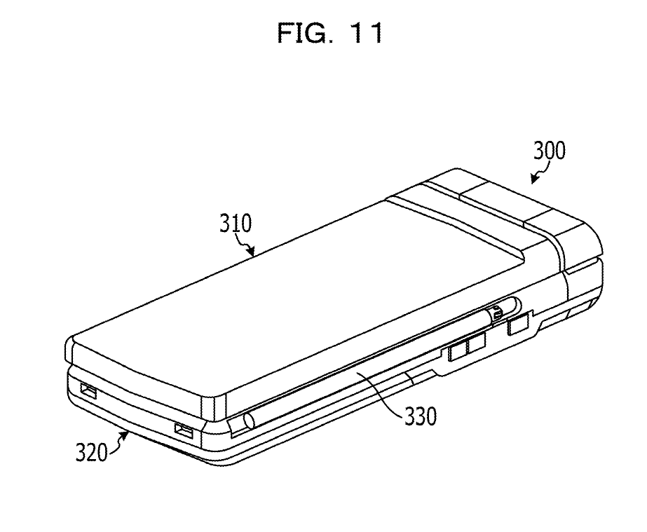

As described above, in the mobile phone apparatus 100 according to the present embodiment, the antenna 140 is retracted into the fixed casing 120. This may prevent the antenna 140 from being subjected to external impact. The mobile phone apparatus 100 according to the present embodiment may increase versatility in design by having the antenna 140 retracted into the fixed casing 120. For example, if the antenna is externally mounted on the casing as illustrated in FIG. 11, this limits the versatility in designing a mobile phone apparatus in that the antenna is constantly visible to the user. In contrast, the mobile phone apparatus 100 according to the present embodiment allows the antenna 140 to be retracted into the recess 124. Thus, the antenna 140 may be hidden from the user's eyes. This allows the mobile phone apparatus 100 according to the present embodiment to be designed with increased versatility.

In the mobile phone apparatus 100 according to the present embodiment, the supporting member 130 is used to support the antenna 140 and also used to block in a watertight manner the through hole 124b that connects the recess 124, which is the non-waterproof area, to the waterproof area. This allows the antenna 140, which is retractable into the fixed casing 120, to be electrically connected to the substrate 127 while the waterproof property is maintained in the mobile phone apparatus 100 according to the present embodiment. Thus, in the mobile phone apparatus 100 according to the present embodiment, the waterproof property may be ensured and damage to the antenna 140 may be prevented.

In the mobile phone apparatus 100 according to the present embodiment, the metal retainer 150 secures the supporting member 130 to the recess 124 and connects the supporting member 130 to the substrate 127. By doing this, in the mobile phone apparatus 100 according to the present embodiment, the antenna 140 may be electrically connected to the substrate 127 in the waterproof area.

In the mobile phone apparatus 100 according to the present embodiment, the cover 125 is mounted over the recess 124 at the upper side of the recess 124, which is the front surface side of the fixed casing 120. This may prevent the movable casing 110 from contacting the antenna 140 in the mobile phone apparatus 100 according to the present embodiment even when the movable casing 110 moves. Thus, damage to the antenna 140 may be prevented.

In the mobile phone apparatus 100 according to the present embodiment, the cover 125, in which the slide groove 125b that functions in cooperation with the slide groove of the base plate 126 is formed, is mounted over the recess 124. By doing this, the movable casing 110 according to the present embodiment may slide along the slide groove of the base plate 126 even when the recess 124 is formed in a portion of the fixed casing 120.

In the mobile phone apparatus 100 according to the present embodiment, the cover 125, in which the discharge holes 125a that communicate with the recess 124 are formed, is mounted over the recess 124. By doing this, in the mobile phone apparatus 100 according to the present embodiment, water having entered the recess 124 may be discharged to the outside of the recess 124.

In the above-described embodiment, a slide-type mobile phone apparatus is described as an example to which the technology of the mobile terminal apparatus disclosed herein is applied. However, the technology of the mobile terminal apparatus disclosed herein is also applicable to mobile phone apparatuses other than slide-type apparatuses. For example, the technology of the mobile terminal apparatus disclosed herein is also applicable in a similar manner to a straight-type mobile terminal apparatus in which the casing is not divided and a mobile terminal apparatus in which one of casings is movable relative to the other using a folding connecting portion or a planarly rotating connecting portion.

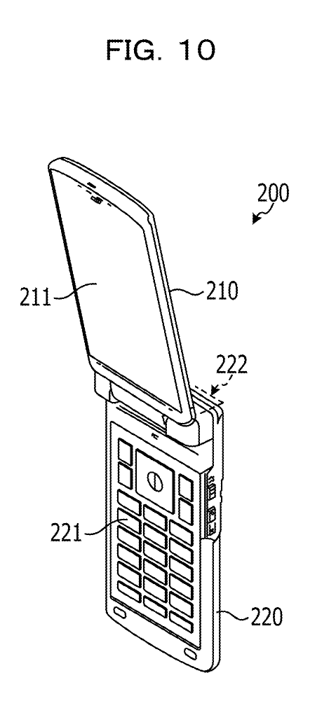

An example of a folding-type mobile phone apparatus to which the technology of the mobile terminal apparatus disclosed herein is applied will be described with reference to FIG. 10. FIG. 10 is a perspective view illustrating an example of the appearance of a folding-type mobile phone apparatus 200. As described in FIG. 10, the mobile phone apparatus 200 includes a movable casing 210 provided with a display portion 211 and a fixed casing 220 provided with an operation portion 221. The movable casing 210 is foldably connected to the fixed casing 220. In such a mobile phone apparatus 200, the antenna 140 may be retracted, for example, into a recess provided in a portion such as a portion 222 of the fixed casing 220.

In the above-described embodiments, examples of mobile phone apparatuses to which the technology of the mobile terminal apparatus disclosed herein is applied have been described. However, the mobile terminal apparatus disclosed herein is not limited to the above-described embodiments. For example, the technology of the mobile terminal apparatus disclosed herein is also applicable to a variety of mobile terminals such as compact information processing terminals, compact music players, portable television sets, and portable game consoles.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that various changes, substitutions, and alterations could be made hereto without departing from the spirit and scope of the invention.

What is claimed is:

1. A mobile terminal apparatus, comprising:
an antenna;
a front outer case having a recess formed therein that houses the antenna, the recess having a first through hole and a second through hole, the first through hole penetrating through a side wall of the front outer case in one end of the recess and the second through hole penetrating through a bottom surface of the recess; and
a supporting member that has a supporting hole formed therein, the supporting hole supporting the antenna that is inserted through the first through hole of the front outer case, at least a portion of the supporting member being inserted through the second through hole in a watertight manner and connecting the antenna supported by the supporting hole to a substrate.

2. The mobile terminal apparatus according to claim 1, further comprising:
a retaining member that secures the supporting member to the recess, the retaining member connecting the antenna to the substrate by connecting the supporting member to the substrate.

3. The mobile terminal apparatus according to claim 1,
wherein the front outer case is provided with a cover member that covers an upper surface of the recess.

4. The mobile terminal apparatus according to claim 3,
wherein the cover member has a slide groove along which a casing slides, the casing being disposed so as to oppose an upper surface of the front outer case.

5. The mobile terminal apparatus according to claim 4,
wherein the cover member has a discharge hole that is communicated with the recess.

6. The mobile terminal apparatus according to claim 1, wherein said portion is a protrusion from a main body of the support and the main body defines the support hole.
